(19) United States
(12) Patent Application Publication
(10) Pub. No.: US 2025/0056631 A1
(43) Pub. Date: Feb. 13, 2025

(54) COMMUNICATION METHOD AND CONTROL TERMINAL

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 18/929,249

(22) Filed: Oct. 28, 2024

Related U.S. Application Data
(63) Continuation of application No. PCT/JP2023/015303, filed on Apr. 17, 2023.

(30) Foreign Application Priority Data
Apr. 28, 2022 (JP) 2022-075441

(51) Int. Cl. H04W 76/10; H04W 8/22; H04W 88/04

(52) U.S. Cl. CPC H04W 76/10; H04W 8/22; H04W 88/04

(57) ABSTRACT

A control terminal for controlling a relay apparatus relaying a radio signal between a base station and a user equipment establishes a wireless connection to a network belonging to a first operator (PLMN) and a wireless connection to a network belonging to a second operator (PLMN). The control terminal controls the relay apparatus based on control received from the network by the control terminal and control received from the network by the control terminal.

### RELATED APPLICATIONS

The present application is a continuation based on PCT Application No. PCT/JP2023/015303, filed on Apr. 17, 2023, which claims the benefit of Japanese Patent Application No. 2022-075441 filed on Apr. 28, 2022. The content of which is incorporated by reference herein in their entirety.

### TECHNICAL FIELD

The present disclosure relates to a communication method and a control terminal used in a mobile communication system.

### BACKGROUND

In recent years, a mobile communication system of the fifth generation (5G) has been attracting attention. New Radio (NR), which is a radio access technology of the 5G system, is capable of wide-band transmission via a high frequency band as opposed to Long Term Evolution (LTE), which is a fourth generation radio access technology.

Since radio signals (radio waves) in the high frequency band such as a millimeter wave band or a terahertz wave band have high rectilinearity, reduction of coverage of a base station is a problem. In order to solve such a problem, a repeater apparatus is attracting attention that is a kind of relay apparatuses relaying a radio signal between a base station and user equipment, and can be controlled from a network (see, for example, Non-Patent Document 1).

Such a repeater apparatus can extend the coverage of the base station while suppressing occurrence of interference by, for example, amplifying a radio signal received from the base station and transmitting the radio signal through directional transmission.

### CITATION LIST

### Non-Patent Literature

Non-Patent Document 1: 3GPP Contribution: RP-213700, “New SI: Study on NR Network-controlled Repeaters”

### SUMMARY

A communication method according to a first aspect is a communication method executed by a control terminal for controlling a relay apparatus relaying a radio signal between a base station and user equipment, the communication method including: the steps of: establishing a wireless connection to a first network belonging to a first operator and a wireless connection to a second network belonging to a second operator different from the first operator; and controlling the relay apparatus based on control received from the first network by the control terminal and control received from the second network by the control terminal.

A control terminal according to a second aspect is a control terminal for controlling a relay apparatus relaying a radio signal between a base station and user equipment, the control terminal including: a communicator configured to establish a wireless connection to a first network belonging to a first operator and a wireless connection to a second network belonging to a second operator different from the first operator; and a controller configured to control the relay apparatus based on control received from the first network by the control terminal and control received from the second network by the control terminal.

### BRIEF DESCRIPTION OF THE DRAWINGS

FIG. 1 is a diagram illustrating a configuration of a mobile communication system according to an embodiment.

FIG. 2 is a diagram illustrating a configuration of a protocol stack of a wireless interface of a user plane handling data.

FIG. 3 is a diagram illustrating a configuration of a protocol stack of a wireless interface of a control plane handling signaling (a control signal).

FIG. 4 is a diagram illustrating a relay apparatus (NCR apparatus) according to a first embodiment.

FIG. 5 is a diagram illustrating the relay apparatus and a control terminal (NCR-UE) according to the first embodiment.

FIG. 6 is a diagram illustrating a control method of the NCR apparatus according to the first embodiment.

FIG. 7 is a diagram illustrating an example of a configuration of a protocol stack in a mobile communication system including the NCR apparatus and the NCR-UE according to the first embodiment.

FIG. 8 is a diagram illustrating an example of configurations of the NCR-UE and the NCR apparatus according to the first embodiment.

FIG. 9 is a diagram illustrating a relay apparatus (RIS apparatus) according to a second embodiment.

FIG. 10 is a diagram illustrating a relay apparatus (RIS apparatus) according to the second embodiment.

FIG. 11 is a diagram illustrating the relay apparatus and a control terminal (RIS-UE) according to the second embodiment.

FIG. 12 is a diagram illustrating a configuration of an RIS-UE and an RIS apparatus according to the second embodiment.

FIG. 13 is a diagram illustrating an example of a configuration of a gNB according to an embodiment.

FIG. 14 is a diagram illustrating an example of downlink signaling from the gNB to the NCR-UE according to the embodiment.

FIG. 15 is a diagram illustrating an example of an operation of the mobile communication system according to the embodiment.

FIG. 16 is a diagram illustrating PLMN according to the embodiment.

FIG. 17 is a diagram illustrating an example of a multiple PLMN connection procedure according to the embodiment.

FIG. 18 is a diagram illustrating an example of a multiple PLMN cooperation procedure according to an embodiment.

FIG. 19 is a diagram illustrating an example of a control terminal-led time division control procedure according to the embodiment.

FIG. 20 is a diagram illustrating an example of a network-led time division control procedure according to the embodiment.

### DESCRIPTION OF EMBODIMENTS

When a relay apparatus such as a repeater apparatus is controlled from a network, a control technique for specifically controlling the relay apparatus has not yet been established, and efficient coverage extension is currently difficult to perform using the relay apparatus.

An object of the present disclosure is to enable appropriate control of a relay apparatus that performs relay transmission between a base station and user equipment.

A mobile communication system according to an embodiment will be described with reference to the drawings. In the description of the drawings, the same or similar parts are denoted by the same or similar reference signs.

### (1) Overview of Embodiments

A communication method according to a first aspect is a communication method executed by a control terminal for controlling a relay apparatus relaying a radio signal between a base station and user equipment, the communication method including the steps of: establishing a wireless connection to a first network belonging to a first operator and a wireless connection to a second network belonging to a second operator different from the first operator; and controlling the relay apparatus based on control received from the first network by the control terminal and control received from the second network by the control terminal.

A communication method of a second aspect is the communication method of the first aspect, wherein the establishing step includes the step of transmitting first notification information regarding the second network to the first network after establishing the wireless connection to the first network.

A communication method of a third aspect is the communication method of the second aspect, wherein the establishing step further includes the step of receiving, from the first network, information for permitting or instructing establishment of the wireless connection to the second network after transmission of the first notification information.

A communication method of a fourth aspect is the communication method of the second or third aspect, wherein the first notification information is information indicating whether the control terminal has a capability or configuration of establishing a wireless connection to a plurality of networks.

A communication method of a fifth aspect is the communication method of any one of the second to fourth aspects, wherein the first notification information includes at least one selected from the group consisting of an identifier of the second network, information indicating whether or not the control terminal has a capability of performing simultaneous communication with the first network and the second network, and frequency information indicating a frequency related to the second network.

A communication method according to a sixth aspect is the communication method according to any one of the first to fifth aspects, further including the step of transmitting, to the second network, second notification information related to control designated to the control terminal from the first network.

A communication method according to a seventh aspect is the communication method according to the sixth aspect, further including the step of receiving, from the first network, control information for designating an operation state to be prohibited as an operation state of the relay apparatus or control information for designating the operation state of the relay apparatus. The transmitting step includes the step of transferring the control information received from the first network to the second network as the second notification information.

A communication method of an eighth aspect is the communication method of the sixth aspect, wherein the second notification information includes information indicating a timing at which the control terminal is controlled from the first network or a timing at which the control terminal is not controlled from the first network.

A communication method of a ninth aspect is the communication method of any one of the first to eighth aspects, wherein the controlling step includes the step of executing control of the relay apparatus according to control from the first network and control of the relay apparatus according to control from the second network in a time division manner.

A communication method of a tenth aspect is the communication method of the ninth aspect, further including the steps of: determining, by the control terminal, a pattern of the time division; and notifying the first network and the second network of the determined pattern.

A communication method of an eleventh aspect is the communication method of the ninth aspect, further including the steps of: receiving, from the first network, information indicating a pattern of the time division determined by the first network; and notifying the second network of the pattern.

A communication method of a twelfth aspect is the communication method of any one of the ninth to eleventh aspects, further including the steps of: acquiring information indicating a throughput in the first network and/or a throughput in the second network; and changing a proportion of the time division based on the throughput.

A control terminal of a thirteenth aspect is a control terminal for controlling a relay apparatus relaying a radio signal between a base station and user equipment, the control terminal including: a communicator configured to establish a wireless connection to a first network belonging to a first operator and a wireless connection to a second network belonging to a second operator different from the first operator; and a controller configured to control the relay apparatus based on control received from the first network by the control terminal and control received from the second network by the control terminal.

### (2) Overview of Mobile Communication System

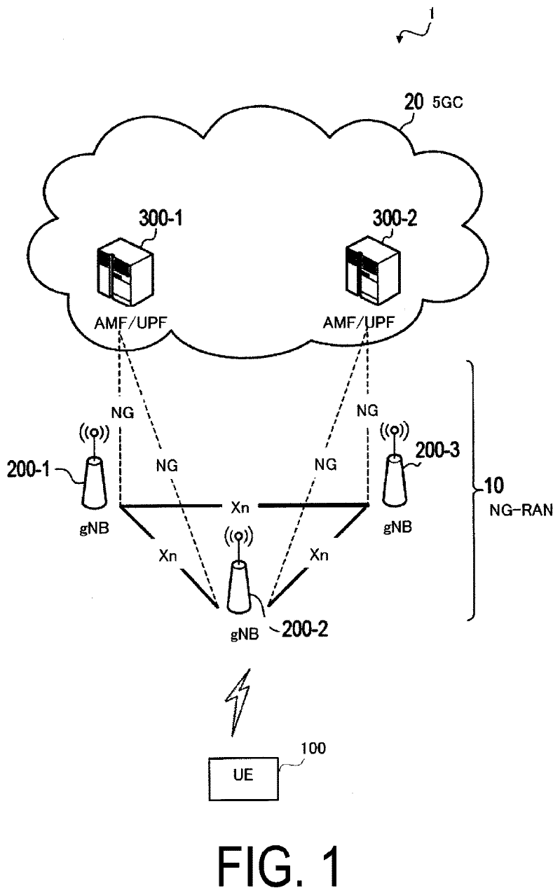

FIG. 1 is a diagram illustrating a configuration of a mobile communication system according to an embodiment. A mobile communication system 1 complies with the 5th Generation System (5GS) of the 3rd Generation Partnership Project (3GPP) (registered trademark; the same applies below) standard. Hereinafter, the 5GS will be described as an example, but a Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface, which is an inter-base station interface. The gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface, which is an interface between a base station and the core network.

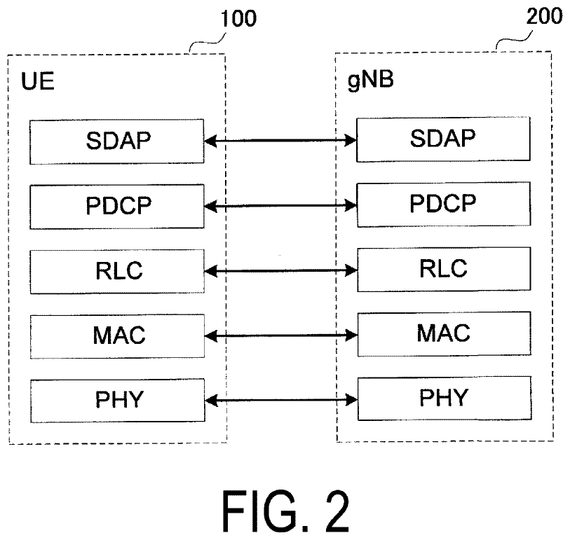

FIG. 2 is a diagram illustrating a configuration of a protocol stack of a wireless interface of a user plane handling data.

A wireless interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). When the RAN is connected to the EPC, the SDAP need not be provided.

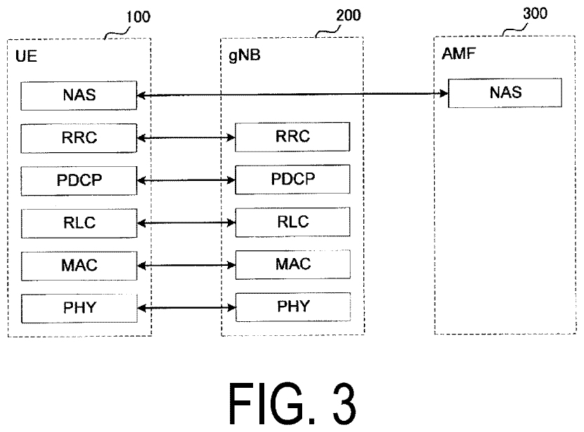

FIG. 3 is a diagram illustrating a configuration of a protocol stack of a wireless interface of a control plane handling signaling (a control signal).

The protocol stack of the wireless interface of the control plane includes a radio resource control (RRC) layer and a non-access stratum (NAS) layer instead of the SDAP layer illustrated in FIG. 2.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer, which is positioned upper than the RRC layer, performs session management, mobility management, and the like. NAS signaling is transmitted between the NAS layer of the UE 100 and the NAS layer of the AMF 300. Note that the UE 100 includes an application layer other than the protocol of the wireless interface. A layer lower than the NAS layer is referred to as an AS layer.

### (3) Relay Apparatus and Control Terminal

An embodiment of the relay apparatus and the control terminal will be described.

### (3.1) First Embodiment

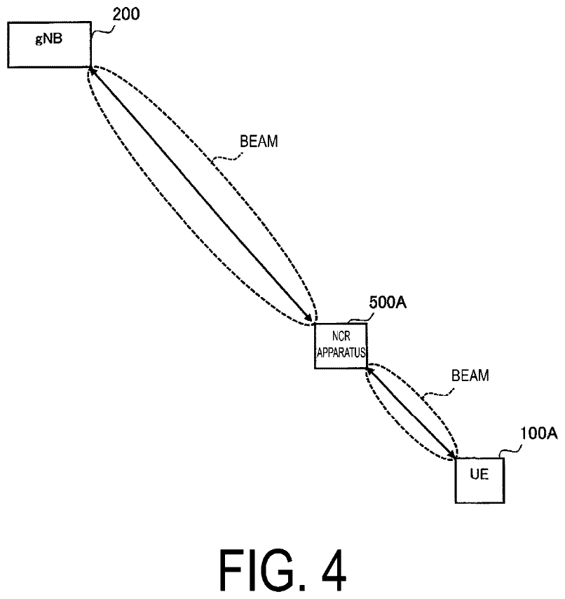

The relay apparatus according to a first embodiment is a repeater apparatus that can be controlled from a network. The 5G/NR is capable of wide-band transmission via a high frequency band compared to the 4G/LTE. Since radio signals in the high frequency band such as a millimeter wave band or a terahertz wave band have high rectilinearity, a problem is reduction of coverage of the gNB 200. In FIG. 4, a UE 100A may be located outside a coverage area of the gNB 200, for example, outside an area where the UE 100A can receive radio signals directly from the gNB 200. The UE 100A may not communicate with the gNB 200 within a line of sight because of obstacles existing between the gNB 200 and the UE 100A.

In the first embodiment, a repeater apparatus (500A) that is a type of a relay apparatus relaying a radio signal between the gNB 200 and the UE 100A and can be controlled from the network is introduced into the mobile communication system 1. Hereinafter, such a repeater apparatus is referred to as a Network-Controlled Repeater (NCR) apparatus. Such a repeater apparatus may be referred to as a smart repeater apparatus.

For example, the NCR apparatus 500A amplifies a radio signal (radio wave) received from the gNB 200 and transmits the radio signal through directional transmission. To be specific, the NCR apparatus 500A receives a radio signal transmitted by the gNB 200 through beamforming. The NCR apparatus 500A amplifies the received radio signal and transmits the amplified radio signal through the directional transmission. Here, the NCR apparatus 500A may transmit the radio signal with a fixed directivity (beam). The NCR apparatus 500A may transmit the radio signal with a variable (adaptive) directional beam. This can efficiently extend the coverage of the gNB 200. Although in the first embodiment, a case in which the NCR apparatus 500A is applied to downlink communication from the gNB 200 to the UE 100A is mainly assumed, the NCR apparatus 500A can also be applied to uplink communication from the UE 100A to the gNB 200.

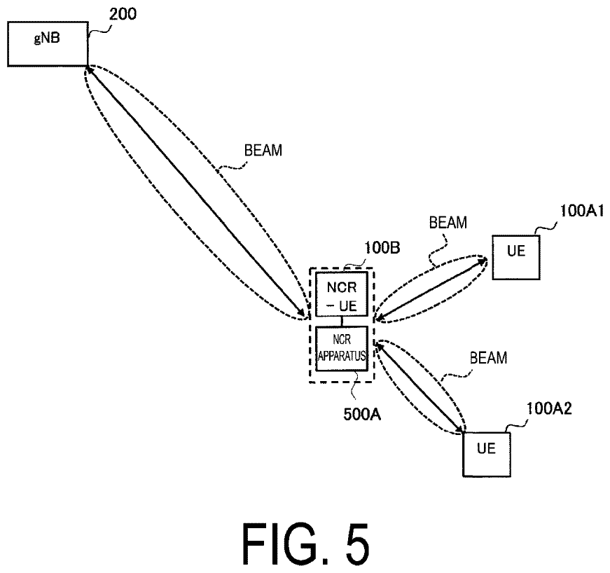

As illustrated in FIG. 5, a new UE (hereinafter referred to as an “NCR-UE”) 100B is introduced that is a type of the control terminal for controlling the NCR apparatus 500A. The NCR-UE 100B controls the NCR apparatus 500A in cooperation with the gNB 200 by establishing a wireless connection to the gNB 200 and performing wireless communication to the gNB 200. By doing so, efficient coverage extension can be achieved using the NCR apparatus 500A. The NCR-UE 100B controls the NCR apparatus 500A according to control from the gNB 200.

The NCR-UE 100B may be configured separately from the NCR apparatus 500A. For example, the NCR-UE 100B may be located near the NCR apparatus 500A and may be electrically connected to the NCR apparatus 500A. The NCR-UE 100B may be connected to the NCR apparatus 500A by wire or wireless. The NCR-UE 100B may be configured to be integrated with the NCR apparatus 500A. The NCR-UE 100B and the NCR apparatus 500A may be fixedly installed at a coverage edge (cell edge) of the base station 200, or on a wall surface or window of any building, for example. The NCR-UE 100B and the NCR apparatus 500A may be installed in, for example, a vehicle to be movable. One NCR-UE 100B may control a plurality of NCR apparatuses 500A.

In the example illustrated in FIG. 5, the NCR apparatus 500A dynamically or semi-statically changes a beam to be transmitted or received. For example, the NCR apparatus 500A forms a beam toward each of a UE 100A1 and a UE 100A2. The NCR apparatus 500A may also form a beam toward the gNB 200. For example, in a communication resource between the gNB 200 and the UE 100A1, the NCR apparatus 500A transmits a radio signal received from the gNB 200 toward the UE 100A1 through beamforming and/or transmits a radio signal received from the UE 100A1 toward the gNB 200 through beamforming. In a communication resource between the gNB 200 and the UE 100A2, the NCR apparatus 500A transmits the radio signal received from the gNB 200 toward the UE 100A2 through beamforming and/or transmits the radio signal received from the UE 100A2 toward the gNB 200 through beamforming. The NCR apparatus 500A may perform null forming (so-called null steering) toward the UE 100 that is not a communication partner (not illustrated) and/or a neighboring gNB 200 (not illustrated) to curb interference instead of or in addition to the beamforming.

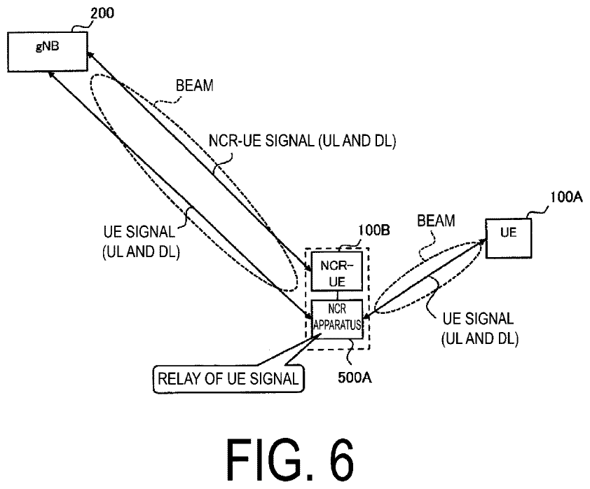

FIG. 6 is a diagram illustrating a control method for the NCR apparatus 500A according to the first embodiment. As illustrated in FIG. 6, the NCR apparatus 500A relays a radio signal (referred to as a “UE signal”) between the gNB 200 and the UE 100A. The UE signal includes an uplink signal transmitted from the UE 100A to the gNB 200 (referred to as a “UE-UL signal”) and a downlink signal transmitted from the gNB 200 to the UE 100A (referred to as a “UE-DL signal”). The NCR apparatus 500A relays the UE-UL signal from the UE 100A to the gNB 200 and relays the UE-DL signal from the gNB 200 to the UE 100A.

The NCR-UE 100B transmits and receives a radio signal (referred to herein as an “NCR-UE signal”) to and from the gNB 200. The NCR-UE signal includes an uplink signal transmitted from the NCR-UE 100B to the gNB 200 (referred to as an “NCR-UE-UL signal”) and a downlink signal (referred to as an “NCR-UE-DL signal”) transmitted from the gNB 200 to the NCR-UE 100B. The NCR-UE-UL signal includes signaling for controlling the NCR apparatus 500A.

The gNB 200 directs a beam to the NCR-UE100B based on the NCR-UE-UL signal from the NCR-UE100B. Since the NCR apparatus 500A is co-located with the NCR-UE 100B, a beam is directed to both the NCR-UE 100B and the NCR apparatus 500A when the gNB 200 directs the beam to the NCR-UE 100B. The gNB 200 transmits the NCR-UE-DL signal and the UE-DL signal using the beam. The NCR-UE 100B receives the NCR-UE-DL signal. The NCR apparatus 500A and the NCR-UE 100B may be at least partially integrated.

For example, in the NCR apparatus 500A and the NCR-UE 100B, functions (for example, antennas) for transmitting and receiving or relaying the UE signal and/or the NCR-UE signal are integrated. The beam includes a transmission beam and/or a reception beam. The beam is a general term for transmission and/or reception under control for maximizing power of a transmission wave and/or a reception wave in a specific direction by adjusting/adapting an antenna weight or the like.

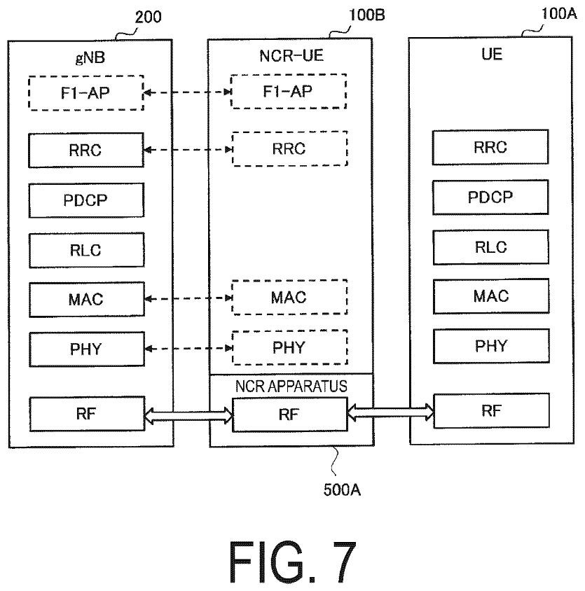

FIG. 7 is a diagram illustrating an example of a configuration of a protocol stack in the mobile communication system 1 including the NCR apparatus 500A and the NCR-UE 100B according to the first embodiment. The NCR apparatus 500A relays a radio signal transmitted and received between the gNB 200 and the UE 100A. The NCR apparatus 500A has a Radio Frequency (RF) function of amplifying and relaying a received radio signal, and performs directional transmission through beamforming (for example, analog beamforming).

The NCR-UE 100B includes at least one layer (entity) selected from the group consisting of PHY, MAC, RRC, and F1-Application Protocol (AP). The F1-AP is a type of a fronthaul interface. The NCR-UE 100B communicates downlink signaling and/or uplink signaling, which will be described below, with the gNB 200 through at least one selected from the group consisting of the PHY, the MAC, RRC, and the F1-AP. When the NCR-UE 100B is a type or a part of the base station, the NCR-UE 100B may communicate with the gNB 200 through an AP of Xn (Xn-AP), which is an inter-base station interface.

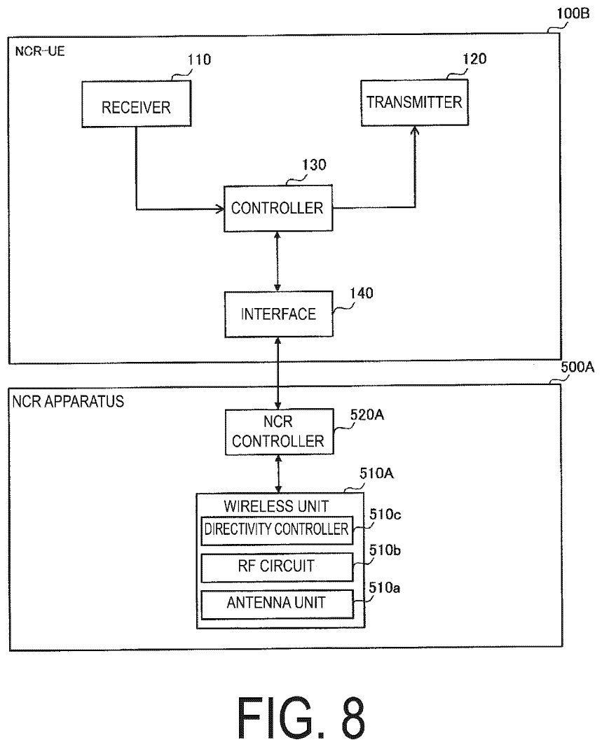

FIG. 8 is a diagram illustrating an example of a configuration of the NCR-UE 100B and the NCR apparatus 500A according to the first embodiment. The NCR-UE 100B includes a receiver 110, a transmitter 120, a controller 130, and an interface 140. The receiver 110 and the transmitter 120 constitute a communicator.

The receiver 110 performs various types of receptions under control of the controller 130. The receiver 110 includes an antenna and a reception device. The reception device converts a radio signal (radio signal) received through the antenna into a baseband signal (a reception signal) and outputs the resulting signal to the controller 130. The transmitter 120 performs various types of transmissions under control of the controller 130. The transmitter 120 includes an antenna and a transmission device. The transmission device converts a baseband signal (a transmission signal) output by the controller 130 into a radio signal and transmits the resultant signal from the antenna.

The controller 130 performs various types of control in the NCR-UE 100B. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. The controller 130 performs a function of at least one layer selected from the group consisting of the PHY, the MAC, the RRC, and the F1-AP.

The interface 140 is electrically connected to the NCR apparatus 500A. The controller 130 controls the NCR apparatus 500A via the interface 140. Note that when the NCR-UE 100B is configured to be integrated with the NCR apparatus 500A, the NCR-UE 100B may not need to include the interface 140. The receiver 110 and the transmitter 120 of the NCR-UE 100B may be configured to be integrated with a wireless unit 510A of the NCR apparatus 500A.

The NCR apparatus 500A includes the wireless unit 510A and an NCR controller 520A. The wireless unit 510A includes an antenna unit 510a including a plurality of antennas (a plurality of antenna elements), an RF circuit 510b including an amplifier, and a directivity controller 510c that controls directivity of the antenna unit 510a. The RF circuit 510b amplifies and relays (transmits) radio signals transmitted and received by the antenna unit 510a. The RF circuit 510b may convert a radio signal, which is an analog signal, into a digital signal, and may reconvert the digital signal into an analog signal after digital signal processing. The directivity controller 510c may perform analog beamforming through analog signal processing, digital beamforming through digital signal processing, or analog and digital hybrid beamforming.

The NCR controller 520A controls the wireless unit 510A in response to a control signal from the controller 130 of the NCR-UE 100B. The NCR controller 520A may include at least one processor. The NCR controller 520A may output information relating to a capability of the NCR apparatus 500A to the NCR-UE 100B. Note that when the NCR-UE 100B is configured to be integrated with the NCR apparatus 500A, the controller 130 of the NCR-UE 100B may also be configured to be integrated with the NCR controller 520A of the NCR apparatus 500A.

In the first embodiment, the receiver 110 of the NCR-UE 100B receives signaling (downlink signaling) used for control of the NCR apparatus 500A, from the gNB 200 through wireless communication. The controller 130 of the NCR-UE 100B controls the NCR apparatus 500A based on the signaling. This enables the gNB 200 to control the NCR apparatus 500A via the NCR-UE 100B.

In the first embodiment, the controller 130 of the NCR-UE 100B acquires NCR capability information indicating the capability of the NCR apparatus 500A from the NCR apparatus 500A (NCR controller 520A). Alternatively, the controller 130 may read the NCR capability information written in a memory of the controller 130 in advance to acquire the NCR capability information. The transmitter 120 of the NCR-UE 100B transmits the acquired NCR capability information to the gNB 200 through wireless communication. The NCR capability information is an example of the uplink signaling from the NCR-UE 100B to the gNB 200. This enables the gNB 200 to ascertain the capability of the NCR apparatus 500A.

### (3.2) Second Embodiment

A relay apparatus according to a second embodiment is a reconfigurable intelligent surface (RIS) apparatus that changes a propagation direction of an incident radio wave (radio signal) through reflection or refraction. The “NCR” in the first embodiment described above may be read as the “RIS”. The RIS can perform beamforming (directivity control) like the NCR by changing characteristics of a metamaterial. The RIS may be able to change a range (distance) of a beam like a lens by controlling a reflection direction and/or a refraction direction of each unit element. For example, the RIS may have a configuration capable of controlling the reflection direction and/or refraction direction of each unit element, and focusing on a near UE (directing a beam) or focusing on a far UE (directing a beam).

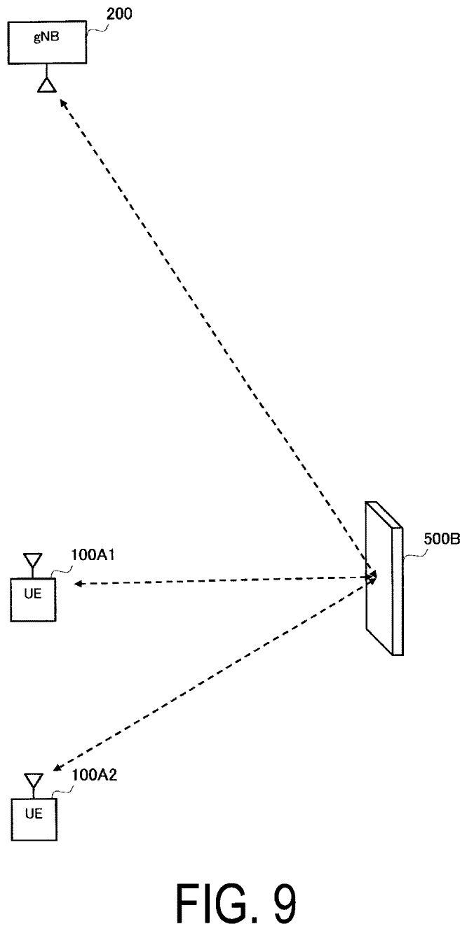

As shown in FIG. 9, the RIS apparatus 500B according to the second embodiment may be a reflective RIS apparatus 500B. Such an RIS apparatus 500B reflects an incident radio wave to change the propagation direction of the radio wave. Here, a reflection angle of the radio wave can be variably configured. The RIS apparatus 500B reflects radio waves incident from the gNB 200 toward each of the UE 100A1 and the UE 100A2. The RIS apparatus 500B may reflect a radio wave incident from each of the UE 100A1 and the UE 100A2 toward the gNB 200. The RIS apparatus 500B dynamically changes a reflection angle of a radio wave. For example, in a communication resource between the gNB 200 and the UE 100A1, the RIS apparatus 500B reflects a radio wave incident from the gNB 200 toward the UE 100A1 and/or reflects a radio wave incident from the UE 100A1 toward the gNB 200. Here, the communication resource includes a time direction resource and/or a frequency direction resource. In a communication resource between the gNB 200 and the UE 100A2, the RIS apparatus 500B reflects a radio wave incident from the gNB 200 toward the UE 100A2 and/or reflects a radio wave incident from the UE 100A2 toward the gNB 200.

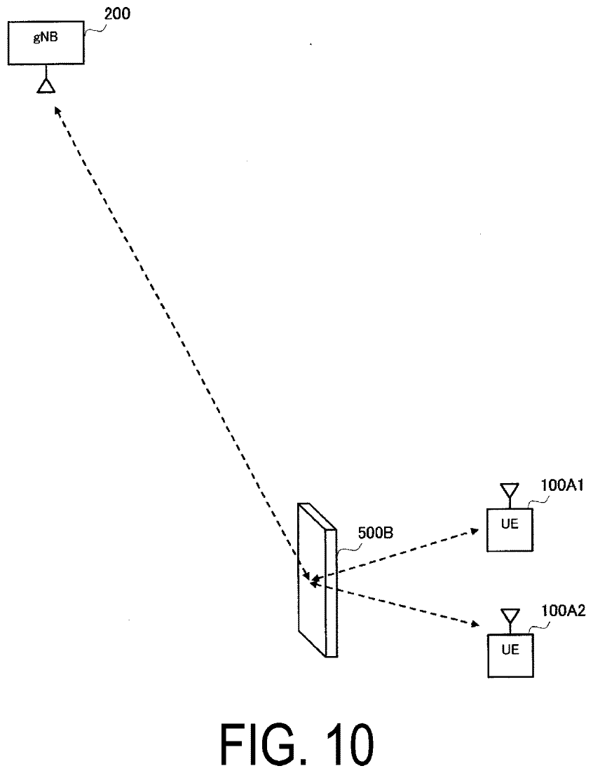

The RIS apparatus 500B may be a transmissive RIS apparatus 500B, as illustrated in FIG. 10. Such an RIS apparatus 500B refracts an incident radio wave to change the propagation direction of the radio wave. Here, a refraction angle of the radio wave can be variably configured. The RIS apparatus 500B refracts radio waves incident from the gNB 200 toward each of the UE 100A1 and the UE 100A2. The RIS apparatus 500B may refract a radio wave incident from each of the UE 100A1 and the UE 100A2 toward the gNB 200. The RIS apparatus 500B dynamically changes the refraction angle of a radio wave. For example, in a communication resource between the gNB 200 and the UE 100A1, the RIS apparatus 500B refracts a radio wave incident from the gNB 200 toward the UE 100A1 and/or refracts a radio wave incident from the UE 100A1 toward the gNB 200. In a communication resource between the gNB 200 and the UE 100A2, the RIS apparatus 500B refracts a radio wave incident from the gNB 200 toward the UE 100A2 and/or refracts a radio wave incident from the UE 100A2 toward the gNB 200.

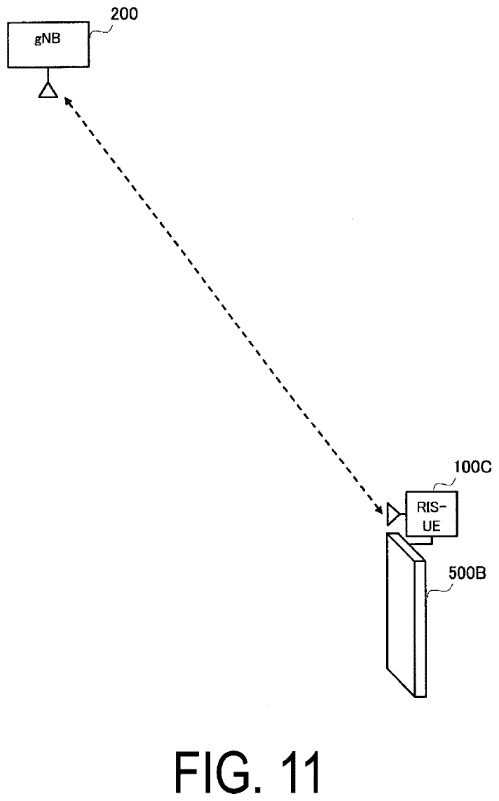

In the second embodiment, a new UE (hereinafter referred to as a “RIS-UE”) 100C that is a control terminal for controlling the RIS apparatus 500B is introduced, as illustrated in FIG. 11. The RIS-UE 100C controls the RIS apparatus 500B in cooperation with the gNB 200 by establishing a wireless connection to the gNB 200 and performing wireless communication with the gNB 200. This can realize efficient coverage extension using the RIS apparatus 500B while suppressing the increase in the installation cost and the decrease in the degree of freedom of the installation of the RIS apparatus 500B. The RIS-UE 100C controls the RIS apparatus 500B according to RIS control information (relay apparatus control information) from the gNB 200.

The RIS-UE 100C may be configured separately from the RIS apparatus 500B. For example, the RIS-UE 100C may be located near the RIS apparatus 500B and may be electrically connected to the RIS apparatus 500B. The RIS-UE 100C may be connected to the RIS apparatus 500B by wire or wireless. The RIS-UE 100C may be configured integrally with the RIS apparatus 500B. The RIS-UE 100C and the RIS apparatus 500B may be fixedly installed on a wall surface or a window, for example. The RIS-UE 100C and the RIS apparatus 500B may be installed in, for example, a vehicle to be movable. One RIS-UE 100C may control a plurality of RIS apparatuses 500B.

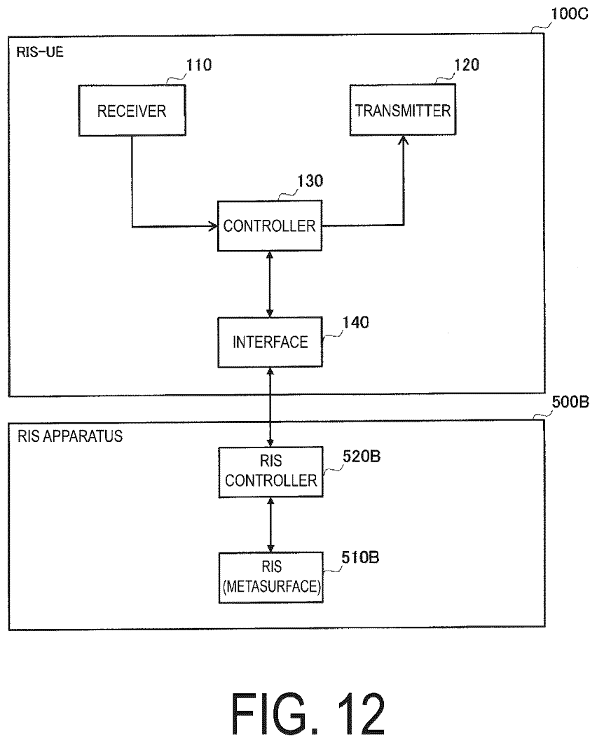

FIG. 12 is a diagram illustrating configurations of the RIS-UE 100C and the RIS apparatus 500B according to the second embodiment. As illustrated in FIG. 12, the RIS-UE 100C includes the receiver 110, the transmitter 120, the controller 130, and the interface 140. The receiver 110 and the transmitter 120 constitute a communicator. Such a configuration is the same as that in the first embodiment described above.

The RIS apparatus 500B includes a RIS 510B and a RIS controller 520B. The RIS 510B is a metasurface configured using metamaterials. For example, the RIS 510B is configured by disposing very small structures in an array form with respect to a wavelength of a radio wave, and it is possible to arbitrarily design a direction and/or a beam shape of a reflected wave by forming the structures in different shapes depending on a disposition place. The RIS 510B may be a transparent dynamic metasurface. The RIS 510B may be configured by stacking a transparent glass substrate on a metasurface substrate on which a large number of small structures are regularly arranged and which is made transparent, and may be capable of dynamically controlling three patterns of a mode of transmitting an incident radio wave, a mode of transmitting a part of a radio wave and reflecting a part thereof, and a mode of reflecting all radio waves by minutely moving the stacked glass substrate.

The RIS controller 520B controls the RIS 510B in response to the RIS control information from the controller 130 in the RIS-UE 100C. The RIS controller 520B may include at least one processor and at least one actuator. The processor interprets the RIS control information from the controller 130 in the RIS-UE 100C to drive the actuator in response to the RIS control information. When the RIS-UE 100C and the RIS apparatus 500B are integrally configured, the controller 130 in the RIS-UE 100C and the RIS controller 520B in the RIS apparatus 500B may also be integrally configured.

### (4) Base Station

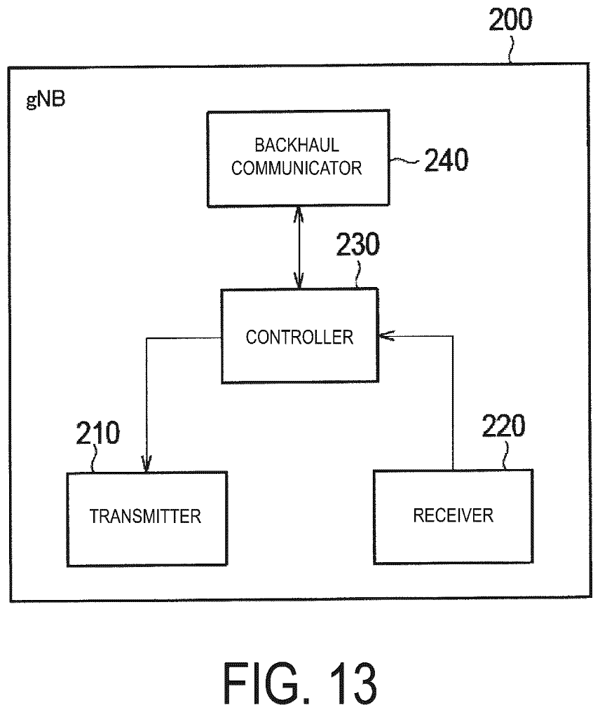

FIG. 13 is a diagram illustrating an example of a configuration of the gNB 200 according to an embodiment. The gNB 200 includes a transmitter 210, a receiver 220, a controller 230, and a backhaul communicator 240.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna. The receiver 220 performs various types of reception under control of the controller 230. The receiver 220 includes an antenna and a reception device. The reception device converts a radio signal received through the antenna into a baseband signal (a reception signal) and outputs the resulting signal to the controller 230. The transmitter 210 and the receiver 220 may be capable of beamforming using a plurality of antennas.

The controller 230 performs various types of controls for the gNB 200. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via the inter-base station interface. The backhaul communicator 240 is connected to the AMF/UPF 300 via the interface between a base station and the core network. Note that the gNB may include a Central Unit (CU) and a Distributed Unit (DU) (that is, functions are divided), and both units may be connected via an F1 interface.

### (5) Example of Communication Sequence

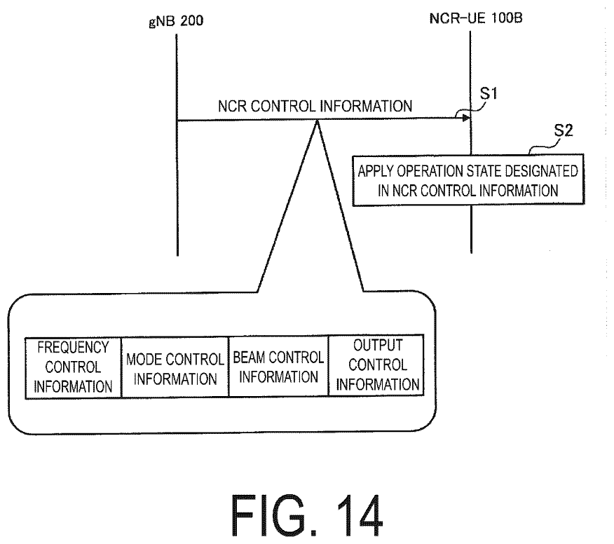

FIG. 14 is a diagram illustrating an example of downlink signaling from the gNB 200 to the NCR-UE 100B according to the embodiment. Although an example in which the relay apparatus is the NCR apparatus 500A will be described herein, the relay apparatus may be the RIS apparatus 500B.

The gNB 200 (transmitter 210) transmits downlink signaling to the NCR-UE 100B. The downlink signaling may be an RRC message that is RRC layer (that is, layer-3) signaling. The downlink signaling may be a MAC control element (CE) that is MAC layer (that is, layer 2) signaling. The downlink signaling may be downlink control information (DCI) that is PHY layer (that is, layer 1) signaling. The downlink signaling may be UE-specific signaling, or broadcast signaling. The downlink signaling may be a fronthaul message (for example, F1-AP message). When the NCR-UE 100B is a type or a part of the base station, the NCR-UE 100B may communicate with the gNB 200 through an AP of Xn (Xn-AP), which is an inter-base station interface.

For example, the gNB 200 (transmitter 210) transmits an NCR control information for designating an operation state of the NCR apparatus 500A as downlink signaling to the NCR-UE 100B having established a wireless connection to the gNB 200 (step S1). The NCR control information for designating an operation state of the NCR apparatus 500A may be MAC CE that is MAC layer (layer 2) signaling or DCI that is PHY layer (layer 1) signaling. However, the NCR control information may be included in an RRC reconfiguration message that is a type of a UE-specific RRC message, which is transmitted the NCR-UE 100B. The downlink signaling may be a message of a layer (for example, an NCR application) higher than the RRC layer. The downlink signaling may be transmitting a message of a layer higher than the RRC layer encapsulated with a message of a layer equal to or lower than the RRC layer. Note that the NCR-UE 100B (transmitter 120) may transmit a response message with respect to the downlink signaling from the gNB 200 in the uplink. The response message may be transmitted in response to the NCR apparatus 500A completing the configuration designated in the downlink signaling or receiving the configuration.

The NCR control information may include frequency control information for designating a center frequency of a radio signal (for example, a component carrier) that is a relay target of the NCR apparatus 500A. When the NCR control information received from the gNB 200 includes the frequency control information, the NCR-UE 100B (controller 130) controls the NCR apparatus 500A such that the NCR apparatus 500A relays a radio signal at a center frequency indicated by the frequency control information (step S2A). The NCR control information may include a plurality of pieces of frequency control information for designating center frequencies different from each other. Since the NCR control information includes the frequency control information, the gNB 200 can designate, via the NCR-UE 100B, a center frequency of the radio signal that is a relay target of the NCR apparatus 500A.

The NCR control information may include mode control information for designating an operation mode of the NCR apparatus 500A. The mode control information may be associated with the frequency control information (center frequency). The operation mode may be any one of a mode in which the NCR apparatus 500A performs non-directional transmission and/or reception, a mode in which the NCR apparatus 500A performs fixed-directional transmission and/or reception, a mode in which the NCR apparatus 500A performs transmission and/or reception with a variable directional beam, and a mode in which the NCR apparatus 500A performs Multiple Input Multiple Output (MIMO) relay transmission. The operation mode may be either a beamforming mode (that is, a mode in which improvement of a desired wave is emphasized) and a null steering mode (that is, a mode in which suppression of an interference wave is emphasized). When the NCR control information received from the gNB 200 includes the mode control information, the NCR-UE 100B (controller 130) controls the NCR apparatus 500A such that the NCR apparatus 500A operates in an operation mode indicated by the mode control information (step S2). Since the NCR control information includes the mode control information, the gNB 200 can designate the operation mode of the NCR apparatus 500A via the NCR-UE 100B.

Here, the mode in which the NCR apparatus 500A performs non-directional transmission and/or reception is a mode in which the NCR apparatus 500A performs relay in all directions and may be referred to as an omnidirectional mode. The mode in which the NCR apparatus 500A performs fixed-directional transmission and/or reception may be a directivity mode realized by one directional antenna. The mode may be a beamforming mode realized by applying fixed phase and amplitude control (antenna weight control) to a plurality of antennas. Any of these modes may be designated (configured) from the gNB 200 to the NCR-UE 100B. The mode in which the NCR apparatus 500A performs transmission and/or reception with a variable directional beam may be a mode in which analog beamforming is performed, a mode in which digital beamforming is performed, or a mode in which hybrid beamforming is performed. The mode may be a mode for forming an adaptive beam specific to a UE 100A. Any of these modes may be designated (configured) from the gNB 200 to the NCR-UE 100B. Note that in the operation mode in which beamforming is performed, beam control information described below may be provided from the gNB 200 to the NCR-UE 100B. The mode in which the NCR apparatus 500A performs MIMO relay transmission may be a mode in which single-user (SU) spatial multiplexing is performed, a mode in which multi-user (MU) spatial multiplexing is performed, and/or a mode in which transmission diversity is performed. Any of these modes may be designated (configured) from the gNB 200 to the NCR-UE 100B. The operation mode may include a mode in which relay transmission by the NCR apparatus 500A is turned on (activated) and a mode in which relay transmission by the NCR apparatus 500A is turned off (deactivated). Any of these modes may be designated (configured) using the NCR control information for the NCR-UE 100B from the gNB 200.

The NCR control information may include the beam control information for designating a transmission direction, a transmission weight, or a beam pattern when the NCR apparatus 500A performs directional transmission. The beam control information may be associated with the frequency control information (center frequency). The beam control information may include a Precoding Matrix Indicator (PMI). The beam control information may include beam forming angle information. When the NCR control information received from the gNB 200 includes the beam control information, the NCR-UE 100B (controller 130) controls the NCR apparatus 500A such that the NCR apparatus 500A forms a transmission directivity (beam) indicated by the beam control information (step S2). Since the NCR control information includes the beam control information, the gNB 200 can control the transmission directivity of the NCR apparatus 500A via the NCR-UE 100B.

The NCR control information may include output control information for designating a degree at which the NCR apparatus 500A amplifies a radio signal (amplification gain) or transmission power. The output control information may be information indicating a difference value (that is, a relative value) between the current amplification gain or transmission power and the target amplification gain or transmission power. When the NCR control information received from the gNB 200 includes the output control information, the NCR-UE 100B (controller 130) controls the NCR apparatus 500A such that the amplification gain or transmission power is changed to that indicated by the output control information (step S2). The output control information may be associated with the frequency control information (center frequency). The output control information may be information for designating any one of an amplification gain, a beamforming gain, and an antenna gain of the NCR apparatus 500A. The output control information may be information for designating the transmission power of the NCR apparatus 500A.

When one NCR-UE 100B controls a plurality of NCR apparatuses 500A, the gNB 200 (transmitter 210) may transmit the NCR control information to the NCR-UE 100B for each NCR apparatus 500A. In this case, the NCR control information may include an identifier of the corresponding NCR apparatus 500A (NCR identifier). The NCR-UE 100B (controller 130) controlling the plurality of NCR apparatuses 500A determines the NCR apparatus 500A to which the NCR control information is applied, based on the NCR identifier included in the NCR control information received from the gNB 200. The NCR identifier may be transmitted together with the NCR control information from the NCR-UE 100B to the gNB 200 even when the NCR-UE 100B controls only one NCR apparatus 500A.

Thus, the NCR-UE 100B (controller 130) controls the NCR apparatus 500A based on the NCR control information from the gNB 200. This enables the gNB 200 to control the NCR apparatus 500A via the NCR-UE 100B.

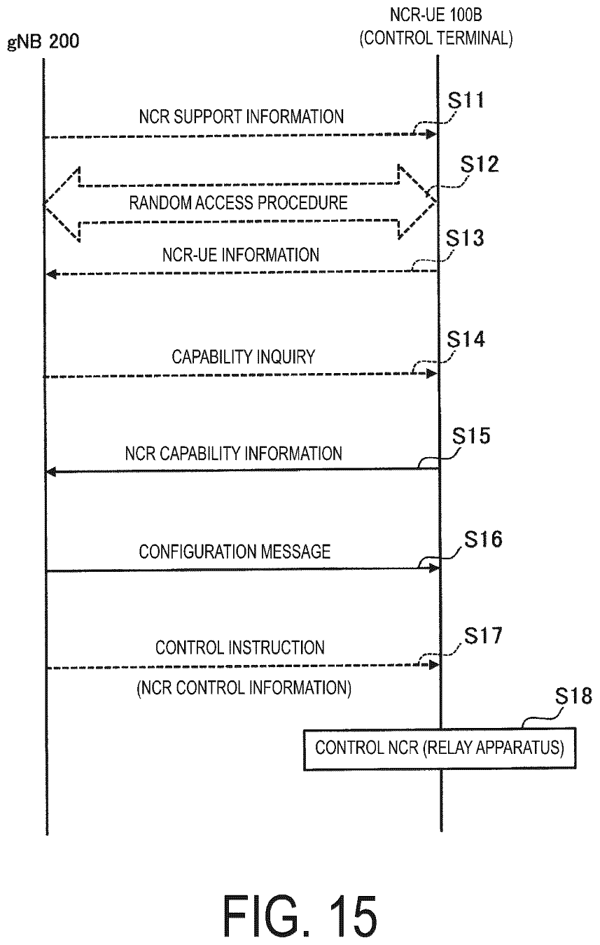

FIG. 15 is a diagram illustrating an example of an operation of the mobile communication system 1 according to the embodiment. In FIG. 15, dashed lines indicate non-essential steps. However, “NCR” in FIG. 15 may be read as “RIS”.

In step S11, the gNB 200 (transmitter 210) broadcasts NCR support information indicating that the gNB 200 supports the NCR-UE 100B (and/or supports grouping described above). For example, the gNB 200 (transmitter 210) broadcasts a system information block (SIB) including the NCR support information. The NCR support information may be information indicating that the NCR-UE 100B is accessible. The gNB 200 (transmitter 210) may broadcast NCR non-support information indicating that the gNB 200 does not support the NCR-UE 100B. The NCR non-support information may be information indicating that the NCR-UE 100B is inaccessible.

In this stage, the NCR-UE 100B may be in the RRC idle state or RRC inactive state. The NCR-UE 100B (controller 130) having not established a wireless connection to the gNB 200 may determine that access to the gNB 200 is permitted in response to reception of the NCR support information from the gNB 200, and perform an access operation for establishing a wireless connection to the gNB 200. The NCR-UE 100B (controller 130) may regard the gNB 200 (cell) to which access is permitted as the highest priority and perform cell reselection.

On the other hand, when the gNB 200 does not broadcast the NCR support information (or when the gNB 200 broadcasts the NCR non-support information), the NCR-UE 100B (controller 130) having not established a wireless connection to the gNB 200 may determine that access (connection establishment) to the gNB 200 is not possible. This enables the NCR-UE 100B to establish a wireless connection only to the gNB 200 capable of handling the NCR-UE 100B.

Note that when the gNB 200 is congested, the gNB 200 may broadcast access restriction information for restricting an access from the UE 100. However, unlike a normal UE 100, the NCR-UE 100B can be regarded as a network-side entity. Therefore, the NCR-UE 100B may ignore the access restriction information from the gNB 200. For example, the NCR-UE 100B (controller 130), when receiving the NCR support information from the gNB 200, may perform an operation to establish a wireless connection to the gNB 200 even if the gNB 200 broadcasts the access restriction information. For example, the NCR-UE 100B (controller 130) may not need to perform (or may ignore) Unified Access Control (UAC). Alternatively, any one or both of Access Category/Access Identity (AC/AI) used in the UAC may be a special value indicating that the access is made by the NCR-UE.

In step S12, the NCR-UE 100B (controller 130) starts a random access procedure for the gNB 200. In the random access procedure, the NCR-UE 100B (transmitter 120) transmits a random access preamble (Msg1) and an RRC message (Msg3) to the gNB 200. In the random access procedure, the NCR-UE 100B (receiver 110) receives a random access response (Msg2) and an RRC message (Msg4) from the gNB 200.

In step S13, the NCR-UE 100B (transmitter 120), when establishing a wireless connection to the gNB 200, may transmit NCR-UE information indicating that the NCR-UE 100B itself is an NCR-UE to the gNB 200. For example, the NCR-UE 100B (transmitter 120), during the random access procedure with the gNB 200, includes the NCR-UE information in the message (for example, Msg1, Msg3, Msg5) for the random access procedure to transmit to the gNB 200. The gNB 200 (controller 230) can recognize that the accessing UE 100 is the NCR-UE 100B, based on the NCR-UE information received from the NCR-UE 100B, and exclude from the access restriction target (in other words, accept the access from), for example, the NCR-UE 100B. When the random access procedure is completed, the NCR-UE 100B transitions from the RRC idle state or the RRC inactive state to the RRC connected state.

In step S14, the gNB 200 (transmitter 120) transmits a capability inquiry message to inquire the capability of the NCR-UE 100B to the NCR-UE 100B. The NCR-UE 100B (receiver 110) receives the capability inquiry message.

In step S15, the NCR-UE 100B (transmitter 120) transmits a capability information message including the NCR capability information to the gNB 200. The capability information message may be an RRC message, for example, a UE Capability message. The gNB 200 (receiver 220) receives the capability information message. The gNB 200 (controller 230) ascertains the capability of the NCR apparatus 500A based on the received capability information message.

In step S16, the gNB 200 (transmitter 120) transmits a configuration message including various configurations regarding the NCR apparatus 500A to the NCR-UE 100B. The NCR-UE 100B (receiver 110) receives the configuration message. The configuration message is a type of the above-described downlink signaling. The configuration message may be an RRC message, for example an RRC reconfiguration message.

In step S17, the gNB 200 (transmitter 120) transmits a control instruction for designating the operation state of the NCR apparatus 500A to the NCR-UE 100B. The control instruction may be the NCR control information (for example, L1/L2 signaling) described above. The NCR-UE 100B (receiver 110) receives the control instruction. The NCR-UE 100B (controller 130) controls the NCR apparatus 500A in response to a control instruction.

In step S18, the NCR-UE 100B controls the NCR apparatus 500A according to the configuration (and control instruction). The NCR-UE 100B may autonomously control the NCR apparatus 500A for at least one group 511A without depending on the control instruction from the gNB 200. For example, the NCR-UE 100B may autonomously control the NCR apparatus 500A based on a position of the UE 100A and/or information received from the UE 100A by the NCR-UE 100B.

### (6) Operation of Multiple PLMNs

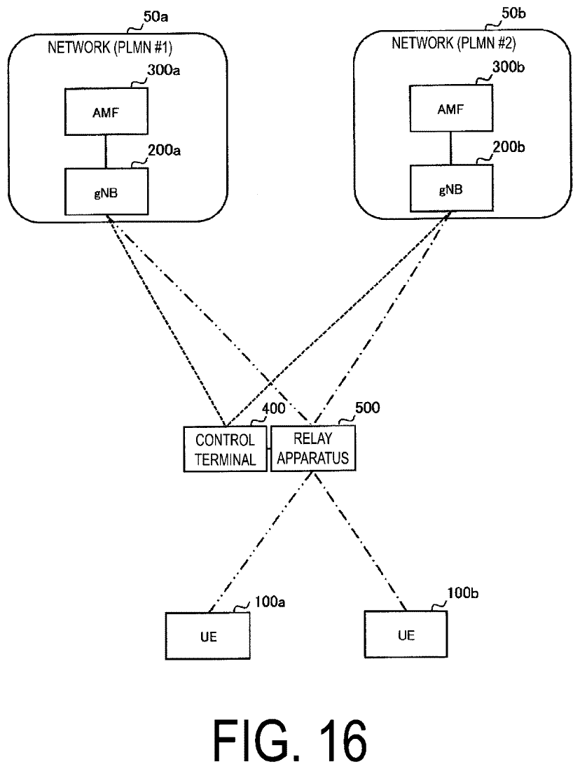

FIG. 16 is a diagram illustrating an operation of a plurality of public land mobile networks (PLMNs) according to an embodiment. The PLMN is a terrestrial wireless communication network (hereinafter simply referred to as a “network”) provided to subscribers by a communication carrier (hereinafter referred to as an “operator”). The network is assigned a PLMN identifier. The PLMN identifier is an identification number of a network and may also be regarded as an identifier of the operator.

As shown in FIG. 16, PLMN #1 is assigned as the PLMN identifier to a network 50a (the first PLMN) belonging to the first operator. The network 50a includes at least one gNB 200a and at least one AMF 300a. PLMN #2 is assigned as the PLMN identifier to a network 50b (second PLMN) belonging to the second operator. The network 50b includes at least one gNB 200b and at least one AMF 300b. Hereinafter, when the networks 50a and 50b are not distinguished, the networks 50a and 50b will be simply referred to as a network 50. Although two networks 50 (that is, two PLMNs) are described as an example, the number of networks 50 (PLMNs) may be three or more. However, it is assumed that no communication interface between the networks 50 exists.

The relay apparatus 500 is the NCR apparatus 500A or RIS apparatus 500B described above. The control terminal 400 is the NCR-UE 100B or RIS-UE 100C described above. The control terminal 400 controls the relay apparatus 500. As described above, the control terminal 400 is co-located with the relay apparatus 500, and for example, at least a portion of the control terminal 400 may be integrated with the relay apparatus 500. The relay apparatus 500 relays a radio signal transmitted and received between the gNB 200a of the network 50a and a UE 100a. The relay apparatus 500 relays a radio signal transmitted and received between the gNB 200b of the network 50b and a UE 100b.

Here, a problem is assumed in which, in the first PLMN (PLMN #1), when the relay apparatus 500 relays a radio signal transmitted and received between the gNB 200a and the UE 100a, the radio signal affects another PLMN (PLMN #2 in FIG. 16) by interference. A problem is assumed in which, in the second PLMN (PLMN #2), when the relay apparatus 500 relays a radio signal transmitted and received between the gNB 200b and the UE 100b, the radio signal affects another PLMN (PLMN #1 in FIG. 16) by interference. In the embodiment, the control terminal 400 receives control from both the network 50a and the network 50b to control the relay apparatus 500, thereby making it possible to curb the problem of interference as described above.

That is, the control terminal 400 that controls the relay apparatus 500 that relays a radio signal between the gNB 200 and the UE 100 establishes a wireless connection to the network 50a belonging to a first operator and a wireless connection to the network 50b belonging to a second operator different from the first operator. The control terminal 400 controls the relay apparatus 500 based on the control received from the network 50a by the control terminal 400 and the control received from the network 50b by the control terminal 400. This makes it possible to curb the occurrence of interference between networks (between PLMNs) while enabling the networks 50a and 50b to share the relay apparatus 500.

### (6.1) Multiple PLMN Connection Procedure

A multiple PLMN connection procedure according to an embodiment will be described. The term “network” used hereinafter may refer to a gNB 200 and/or an AMF 300 within the network.

After establishing the wireless connection to the network 50a, the control terminal 400 transmits first notification information related to the network 50b to the network 50a. This makes it possible for even the network 50a that does not have a communication interface with the network 50b to acquire information on the network 50b from the control terminal 400. For example, the first notification information includes at least one selected from the group consisting of an identifier (PLMN identifier) of the network 50b, information indicating whether or not the control terminal 400 is capable of performing simultaneous communication with the network 50a and the network 50b, and frequency information indicating frequencies related to the network 50b.

After transmission of the first notification information, the control terminal 400 may receive, from the network 50a, information for permitting or instructing establishment of a wireless connection to the network 50b. This makes it possible for the control terminal 400 to establish the wireless connection to the network 50b under the management of the network 50a.

The first notification information may be information indicating whether the control terminal 400 has a capability or configuration of establishing a wireless connection to a plurality of networks. This makes it possible for the network 50a to appropriately perform a determination as to whether to provide a permission or instruction of establishment of the wireless connection to the network 50b to the control terminal 400.

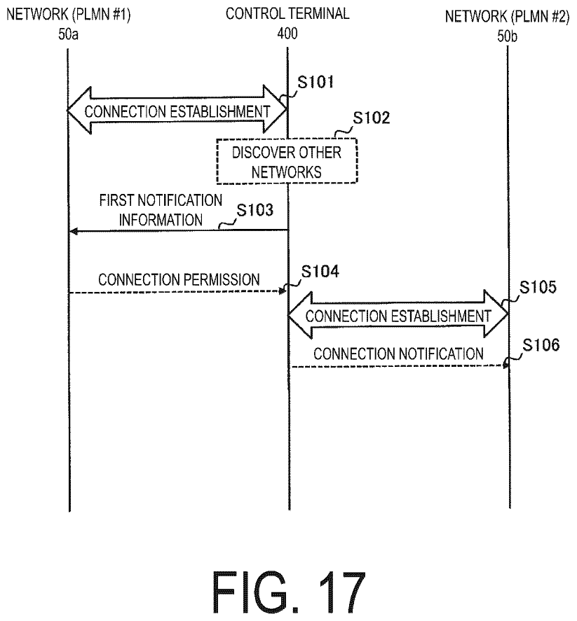

FIG. 17 is a diagram illustrating an example of a multiple PLMN connection procedure according to an embodiment. In FIG. 17, dashed lines indicate non-essential steps.

In step S101, the control terminal 400 establishes a wireless connection (for example, an RRC connection) with the network 50a of the PLMN #1. Here, the PLMN #1 may be a primary PLMN. The primary PLMN may be set in advance by a subscriber identity module (SIM) or the like of the control terminal 400. PLMN #2 may be preset in the SIM or the like as a secondary PLMN.

In step S102, the control terminal 400 discovers a network 50b of another PLMN #2 (for example, the secondary PLMN) to which the control terminal 400 can be connected. The control terminal 400 may discover the network 50b based on a PLMN identifier included in broadcast information transmitted by the gNB 200b of the network 50b.

In step S103, the control terminal 400 transmits the first notification information to the network 50a. The network 50a receives the first notification information. The first notification information may be information (message) indicating that the control terminal 400 supports multiple PLMNs. The first notification information may be information (message) indicating that multiple PLMNs (for example, the primary PLMN and the secondary PLMN) are preset in the SIM or the like. The control terminal 400 may transmit the first notification information in response to discovery of the other PLMN (for example, the secondary PLMN) to which the control terminal 400 can be connected. The control terminal 400 may transmit the first notification information in response to establishment of the wireless connection to the network 50b. The first notification information may include at least one information element (information field) among the following A1) to A3).

A1) PLMN identifier of other PLMN

For example, the control terminal 400 includes the PLMN identifier set as the secondary PLMN in the first notification information.

A2) An information element indicating whether communication with the PLMN #1 can be performed at the same time at the time of communication with another PLMN is performed.

The information element may be an information element indicating the number of wireless devices (transmission devices and/or reception devices) included in the control terminal 400.

A3) Frequency information of other PLMNs

For example, the control terminal 400 includes the operating frequency of the secondary PLMN in the first notification information. Here, the operating frequency may be a frequency included in an operating frequency band of the relay apparatus 500. The operating frequency may be an operating frequency of the relay apparatus 500 set from the network 50a, or may be a corresponding frequency as a hardware capability.

In step S104, the network 50a transmits a connection permission for permitting connection to the network 50b to the control terminal 400. The control terminal 400 receives the connection permission. The network 50a may permit the control terminal 400 to connect to the network 50b based on contract information between the PLMN #1 and the PLMN #2. In a case where the first notification information is transmitted when the control terminal 400 is connected to the network 50b, the network 50a may transmit, to the control terminal 400, a connection permission for permitting maintenance of the connection to the network 50b (or a disconnection instruction for instructing disconnection of the connection to the network 50b) in step S104.

In step S105, the control terminal 400 establishes a wireless connection (for example, an RRC connection) to the network 50b of the PLMN #2.

In step S106, the control terminal 400 may notify the network 50b that the control terminal 400 is connected to the network 50a. The control terminal 400 may notify that the network 50b is the secondary PLMN. The notification may include information such as a PLMN identifier, availability of simultaneous communication, and a frequency, like the first notification information described above.

When the control terminal 400 establishes the wireless connection to the networks 50a and 50b in this way, the network 50a and/or the network 50b sets and/or instructs control of the relay apparatus 500 with respect to the control terminal 400. Such selection processing will be described in detail later.

### (6.2) Multiple PLMN Cooperation Procedure

A multiple PLMN cooperation procedure according to an embodiment will be described. The multiple PLMN cooperation procedure is an example of a procedure after the control terminal 400 establishes the wireless connection to the network 50a and the network 50b.

The control terminal 400 transmits, to the network 50b, second notification information related to control designated to the control terminal 400 from the network 50a. This makes it possible for the network 50b to ascertain the content of the control designated to the control terminal 400 from the network 50a.

The control terminal 400 may receive, from the network 50a, control information for designating an operation state to be prohibited (referred to as a “prohibited operation state”) as an operation state of the relay apparatus 500 or control information for designating the operation state of the relay apparatus 500. The control terminal 400 may transfer the control information received from the network 50a to the network 50b as the second notification information. This makes it easy for the network 50b to appropriately perform control of the relay apparatus 500 using the network 50b in consideration of the operation state or the prohibited operation state of the relay apparatus 500 designated by the network 50a.

The second notification information may include information indicating a timing at which the control terminal 400 is controlled from the network 50a or a timing at which the control terminal 400 is not controlled from the network 50a. This makes it easy for the network 50b to appropriately determine a control timing of the relay apparatus 500 by the network 50b in consideration of the timing.

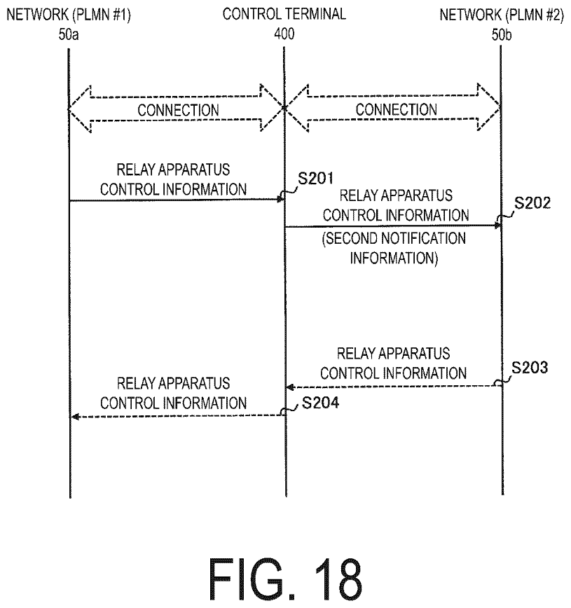

FIG. 18 is a diagram illustrating an example of a multiple PLMN cooperation procedure according to an embodiment. In FIG. 18, dashed lines indicate non-essential steps.

In step S201, the network 50a transmits the relay apparatus control information to the control terminal 400. The control terminal 400 receives the relay apparatus control information. The relay apparatus control information may be the above-described downlink signaling. The relay apparatus control information may be an RRC message, a MAC CE, a DCI, or a combination thereof. The relay apparatus control information may include at least one information element (information field) among the following B1) to B3).

B1) Control information indicating an operation state of the relay apparatus 500

This is an information element indicating the operation state of the relay apparatus 500 designated by the network 50a and is, for example, an information element for performing a configuration of a beam direction, for beamforming. The information element may be transmitted as a set with timing information indicating a timing (a cycle, a slot, or the like) to which the operation state is applied.

B2) Control information indicating a prohibited operation state of the relay apparatus 500

This is an information element indicating the prohibited operation state of the relay apparatus 500 designated by the network 50a and is, for example, an information element for setting (designating) a beam direction prohibited from being used, for beamforming.

B3) Information element for requesting (or permitting) notifying the network 50b of the control information of B1) and/or B2).

The control terminal 400 determines whether to transmit the second notification information to the network 50b, based on the information element. The control terminal 400 may be set from the network 50b to transmit (report) the control information of the network 50a.

In step S202, the control terminal 400 transmits the control information, which is received from the network 50a, to the network 50b as the second notification information. The network 50b receives the second notification information. As described above, the second notification information includes the operation state of the relay apparatus 500 and/or the prohibited operation state of the relay apparatus 500 set by the network 50a.

The network 50b, for example, may control the relay apparatus 500 via the control terminal 400 without using the operation state of the relay apparatus 500 prohibited by the network 50a. The network 50b may perform optimal communication with the UE 100b in the operation state of the relay apparatus 500 controlled by the network 50a. The network 50b may control the relay apparatus 500 via the control terminal 400 at a timing when the operation state is not designated from the network 50a.

Steps S203 and S204 are operations in a reverse direction of steps S201 and S202. That is, in step S203, the network 50b transmits the relay apparatus control information to the control terminal 400. The control terminal 400 receives the relay apparatus control information. In step S204, the control terminal 400 may transfer the relay apparatus control information to the network 50a.

Each network 50 may perform only setting of control of the relay apparatus 500 on the control terminal 400, and the control terminal 400 may autonomously perform specific control of the relay apparatus 500. For example, the control terminal 400 may autonomously control the relay apparatus 500 based on a position of each UE 100 or a radio signal received from each UE 100.

### (6.3) Time Division Control Procedure

A time division control procedure according to an embodiment will be described.

The control terminal 400 executes control of the relay apparatus 500 according to control from the network 50a and control of the relay apparatus 500 according to control from the network 50b in a time division manner. Accordingly, since a control right of the relay apparatus 500 is given to the networks 50a and 50b in a time division manner, it becomes easy for the networks 50a and 50b to share the relay apparatus 500.

The control terminal 400 may acquire information indicating a throughput in the network 50a and/or a throughput in the network 50b and change a proportion of time division based on the throughput. Accordingly, it becomes easy to ensure fairness between the network 50a and the network 50b under the assumption that the network 50a and the network 50b share the relay apparatus 500.

(6.3.1) Control Terminal-led Time Division Control Procedure In a control terminal-led time division control procedure, the control terminal 400 determines a time division pattern. The control terminal 400 notifies the network 50a and the network 50b of the determined pattern.

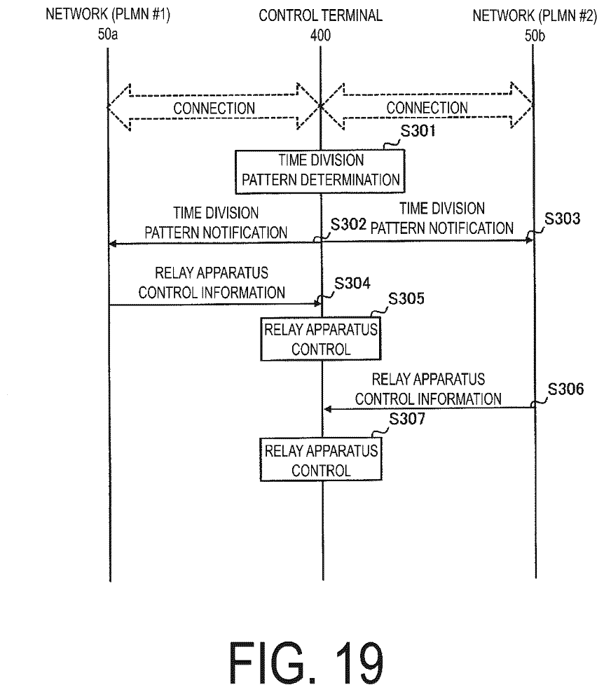

FIG. 19 is a diagram illustrating an example of a control terminal-led time division control procedure according to the embodiment. It is assumed that the control terminal 400 is connected to the network 50a and the network 50b.

In step S301, the control terminal 400 divides the time direction resources into n (into two in the example of FIG. 19) and allocates the divided resources to the respective connected networks 50. Here, “n” indicates the number of networks 50 to which the control terminal 400 is connected. For example, the control terminal 400 divides one radio frame (that is, ten subframes) into two, each including five subframes, and allocates the former five subframes to PLMN #1 and the latter five subframes to PLMN #2. Although five subframes are grouped in this example, the subframes may be allocated in any manner, for example, alternately (even-numbered subframes and odd-numbered subframes). The control terminal 400 specifies the allocation pattern (time division pattern such as a bitmap). The pattern may be represented by, for example, a bitmap. The pattern may be represented by a start timing and a cycle. The control terminal 400 may perform the processing of step S301 according to content (for example, an allocation cycle) set in advance from the network 50.

In steps S302 and S303, the control terminal 400 notifies each of the networks 50a and 50b of the time division pattern determined in step S301. Each network 50 transmits control information to the control terminal 400 in the time allocated to the network 50, based on the notified time division pattern (steps S304 and S306). Each network 50 transmits, to the control terminal 400, control information for setting the operation state of the relay apparatus 500 in the time allocated to the network 50, based on the notified time division pattern. The control terminal 400 controls the relay apparatus 500 according to the allocated control information from the network 50 in the allocated time (steps S305 and S307).

The network 50 may transmit a request for changing of the time allocated to the network 50 (for example, a request for changing to another time timing or a request for changing of the cycle) to the control terminal 400.

The control terminal 400 may change a time division control proportion depending on a system throughput when the relay apparatus 500 is used and when the relay apparatus 500 is not used. Each network 50 notifies the control terminal 400 of a throughput at the control timing of the relay apparatus 500 and/or a throughput at a timing other than the control timing under a situation where control of the relay apparatus 500 is performed according to the time allocation. The throughput may be a total throughput of the system. The throughput may be a (total) throughput of a specific user (for example, a user via the relay apparatus 500). The throughput may be indicated by some index. For example, an actual throughput is expressed as a percentage of a theoretical system throughput. The control terminal 400 adjusts a time proportion so that the throughput is balanced between the networks on a long-term basis or on an average basis. For example, the control terminal 400 re-allocates a large portion of time to a network in which a throughput deteriorates at a timing at which the relay apparatus 500 cannot be controlled.

### (6.3.2) Network-led Time Division Control Procedure

In a network-led time division control procedure, the control terminal 400 receives information indicating a time division pattern determined by the network 50a from the network 50a and notifies the network 50b of the pattern.

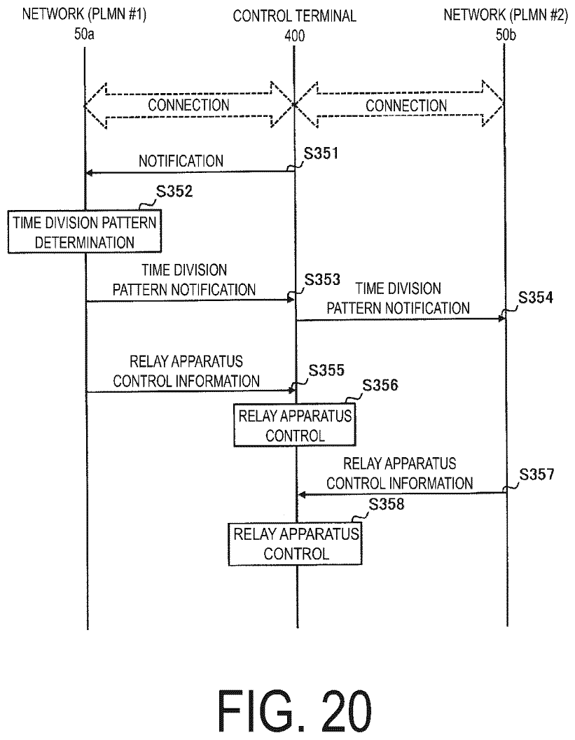

FIG. 20 is a diagram illustrating an example of the network-led time division control procedure according to an embodiment. It is assumed that the control terminal 400 is connected to the network 50a and the network 50b.

In step S351, the control terminal 400 notifies the network 50a of the number of networks 50 to which the control terminal 400 is connected (and/or the PLMN identifier of each network 50 to which the control terminal 400 is connected). The network 50a may be a primary PLMN of the control terminal 400. The control terminal 400 may notify the network 50a of at least one selected from the group consisting of the number of UEs 100 being served, a traffic volume, and a radio resource usage rate for another PLMN.

In step S352, the network 50a divides the time direction resources into n (into two in the example of FIG. 20), based on the content of the notification in step S351, and allocates the divided resources to the respective networks 50. A method of determining the time division pattern is the same as the control terminal-led time division control procedure described above.

In step S353, the network 50a notifies the control terminal 400 of the time division pattern determined in step S352. The pattern may be represented by, for example, a bitmap. The pattern may be represented by a start timing and a cycle. The pattern may be transmitted as a set with the network information. For example, when the control terminal 400 notifies the network 50a of the number of connected networks in step S351, the network 50a associates each of the own network and the other network with the time division pattern. In a concrete example, the network 50a associates subframes #0 to #3 with its own PLMN, subframes #4 to #6 with another PLMN #1, and subframes #7 to #9 with another PLMN #2. When the PLMN identifier is notified from the control terminal 400 in step S351, the network 50a associates the PLMN identifier with the time division pattern. For example, the network 50a associates the subframes #0 to #4 with the PLMN #1 and the subframes #5 to #9 with the PLMN #2.

In step S354, the control terminal 400 notifies the network 50b of the time division pattern allocated to the network 50b. The network 50b may be a secondary PLMN of the control terminal 400. When the time division pattern is associated with each network 50 or each PLMN identifier in step S352, the network 50b is notified of the time division pattern according to the association. The subsequent operation (steps S355 to S358) is the same as the control terminal-led time division control procedure described above.

The network 50a may change the time division control proportion depending on the system throughput when the relay apparatus 500 is used and when the relay apparatus 500 is not used. The network 50b notifies the control terminal 400 of a throughput at the control timing of the relay apparatus 500 and/or a throughput at a timing other than the control timing, and the control terminal 400 notifies the network 50a of the throughput. The throughput may be transmitted as a set with the PLMN identifier. The network 50a adjusts the time proportion so that the throughput is balanced between the networks on a long-term basis or on an average basis.

### (7) Other Embodiments

NCR/RIS control information transmitted from the gNB 200 to the NCR-UE 100B or the RIS-UE 100C may be information for controlling a direction and/or a focal length of a beam relayed (output) by the NCR apparatus 500A or the RIS apparatus 500B. The information for controlling the direction is, for example, an antenna weight as described above. The information for controlling the focal length is information for the NCR apparatus 500A or the RIS apparatus 500B to focus the beam depending on a distance between the NCR apparatus 500A or the RIS apparatus 500B and the UE 100A. Such information may be information indicating the distance between the NCR apparatus 500A or the RIS apparatus 500B and the UE 100A. Such information may be information indicating a focal length (for example, a focal range such as near or far). The NCR apparatus 500A or the RIS apparatus 500B adjusts a focal length of the beam, based on the information. The RIS apparatus 500B controls a reflection (or refraction) angle of an element outside a metasurface plane and a reflection (or refraction) angle of an element inside the metasurface plane so that the angles are different (have a difference) to adjust the focal length of the beam like a lens.

In the above-described embodiment, the frequency control information may include a cell ID for identifying a cell and/or a BWP ID for identifying a bandwidth part (BWP). The BWP refers to a part of a frequency band of a cell.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

In the embodiment described above, an example in which the base station is an NR base station (that is, a gNB) is described; however, the base station may be an LTE base station (an eNB). The base station may be a relay node such as an Integrated Access and Backhaul (IAB) node. The base station may be a Distributed Unit (DU) of the IAB node.

A program causing a computer to execute each of the processes performed by the UE 100 (NCR-UE 100B, RIS-UE 100C) or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits that execute processing performed by the UE 100 or the gNB 200 may be integrated, and at least a part of the UE 100 or the gNB 200 may be configured as a semiconductor integrated circuit (chipset or system on a chip (SoC)).

The phrases “based on” and “depending on” used in the present disclosure do not mean “based only on” and “only depending on,” unless specifically stated otherwise. The phrase “based on” means both “based only on” and “based at least in part on”. The phrase “depending on” means both “only depending on” and “at least partially depending on”. The term “obtain” or “acquire” may mean to obtain information from stored information, may mean to obtain information from information received from another node, or may mean to obtain information by generating the information. The term “transmit” may mean performing processing of at least one layer in a protocol stack used for transmission, or may mean physically transmitting a signal in a wireless or wired manner. The term “transmitting” may mean a combination of performing the processing of the at least one layer and physically transmitting a signal in a wireless or wired manner. The term “receive” may mean performing processing of at least one layer in a protocol stack used for reception, or may mean physically receiving a signal in a wireless or wired manner. The term “receiving” may mean a combination of performing the processing of the at least one layer and physically receiving a signal in a wireless or wired manner. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### SUPPLEMENTS

Characteristics relating to the embodiments described above are described as supplements.

(1)

A communication method executed by a control terminal for controlling a relay apparatus relaying a radio signal between a base station and a user equipment, the communication method including:
establishing a wireless connection to a first network belonging to a first operator and a wireless connection to a second network belonging to a second operator different from the first operator; and
controlling the relay apparatus based on control received from the first network by the control terminal and control received from the second network by the control terminal.

(2)

The communication method according to (1), wherein the establishing includes transmitting first notification information regarding the second network to the first network after establishing the wireless connection to the first network.

(3)

The communication method according to (2), wherein the establishing further includes receiving, from the first network, information for permitting or instructing establishment of the wireless connection to the second network after transmission of the first notification information.

(4)

The communication method according to (2) or (3), wherein the first notification information is information indicating whether the control terminal has a capability or configuration of establishing a wireless connection to a plurality of networks.

(5)

The communication method according to any one of (2) to (4), wherein the first notification information includes at least one selected from the group consisting of an identifier of the second network, information indicating whether or not the control terminal has a capability of performing simultaneous communication with the first network and the second network, and frequency information indicating a frequency related to the second network.

(6)

The communication method according to any one of (2) to (5), further including: transmitting, to the second network, second notification information related to control designated to the control terminal from the first network.

(7)

The communication method according to (6), further including: receiving, from the first network, control information for designating an operation state to be prohibited as an operation state of the relay apparatus or control information for designating the operation state of the relay apparatus, wherein the transmitting includes transferring the control information received from the first network to the second network as the second notification information.

(8)

The communication method according to (6) or (7), wherein the second notification information includes information indicating a timing at which the control terminal is controlled from the first network or a timing at which the control terminal is not controlled from the first network.

(9)

The communication method according to any one of (1) to (8), wherein the controlling includes executing control of the relay apparatus according to control from the first network and control of the relay apparatus according to control from the second network in a time division manner.

(10)

The communication method according to (9), further including:
determining, by the control terminal, a pattern of the time division; and
notifying the first network and the second network of the determined pattern.

(11)

The communication method according to (9) or (10), further including:
receiving, from the first network, information indicating a pattern of the time division determined by the first network; and
notifying the second network of the pattern.

(12)

The communication method according to any one of (9) to (11), further including:
acquiring information indicating a throughput in the first network and/or a throughput in the second network; and
changing a proportion of the time division based on the throughput.

(13)

A control terminal for controlling a relay apparatus relaying a radio signal between a base station and user equipment, the control terminal including:
a communicator configured to establish a wireless connection to a first network belonging to a first operator and a wireless connection to a second network belonging to a second operator different from the first operator; and
a controller configured to control the relay apparatus based on control received from the first network by the control terminal and control received from the second network by the control terminal.

### REFERENCE SIGNS

1: Mobile communication system
100: UE
100B: NCR-UE
100C: RIS-UE
110: Receiver
120: Transmitter
130: Controller
140: Interface
200: gNB
210: Transmitter
220: Receiver
230: Controller
240: Backhaul communicator
300: AMF
400: Control terminal
500: Relay apparatus
500A: NCR apparatus
500B: RIS apparatus
510A: Wireless unit
510a: Antenna unit
510b: RF circuit
510c: Directivity controller
520A: NCR controller
520B: RIS controller

1. A communication method executed by a control terminal configured to control a relay apparatus configured to relay a radio signal between a base station and a user equipment, the communication method comprising:
establishing a wireless connection to a first network belonging to a first operator and a wireless connection to a second network belonging to a second operator different from the first operator; and
controlling the relay apparatus based on control received from the first network by the control terminal and control received from the second network by the control terminal.

2. The communication method according to claim 1, wherein the establishing includes transmitting first notification information regarding the second network to the first network after establishing the wireless connection to the first network.

3. The communication method according to claim 2, wherein the establishing further includes receiving, from the first network, information for permitting or instructing establishment of the wireless connection to the second network after transmission of the first notification information.

4. The communication method according to claim 2, wherein the first notification information is information indicating whether or not the control terminal has a capability or configuration of establishing a wireless connection to a plurality of networks.

5. The communication method according to claim 2, wherein the first notification information includes at least one selected from the group consisting of an identifier of the second network, information indicating whether or not the control terminal has a capability of performing simultaneous communication with the first network and the second network, and frequency information indicating a frequency related to the second network.

6. The communication method according to claim 1, further comprising:
transmitting, to the second network, second notification information related to control designated to the control terminal from the first network.

7. The communication method according to claim 6, further comprising:
receiving, from the first network, control information for designating an operation state prohibited as an operation state of the relay apparatus or control information for designating the operation state of the relay apparatus, wherein
the transmitting includes transferring the control information received from the first network to the second network as the second notification information.

8. The communication method according to claim 6, wherein the second notification information includes information indicating a timing at which the control terminal is controlled from the first network or a timing at which the control terminal is not controlled from the first network.

9. The communication method according to claim 1, wherein the controlling includes executing control of the relay apparatus according to control from the first network and control of the relay apparatus according to control from the second network in a time division manner.

10. The communication method according to claim 9, further comprising:
determining, by the control terminal, a pattern of the time division; and
notifying the first network and the second network of the determined pattern.

11. The communication method according to claim 9, further comprising:
receiving, from the first network, information indicating a pattern of the time division determined by the first network; and
notifying the second network of the pattern.

12. The communication method according to claim 9, further comprising:
acquiring information indicating a throughput in the first network and/or a throughput in the second network; and
changing a proportion of the time division based on the throughput.

13. A control terminal configured to control a relay apparatus configured to relay a radio signal between a base station and a user equipment, the control terminal comprising:
a communicator configured to establish a wireless connection to a first network belonging to a first operator and a wireless connection to a second network belonging to a second operator different from the first operator; and
a controller configured to control the relay apparatus based on control received from the first network by the control terminal and control received from the second network by the control terminal.
